(19) United States
(12) Patent Application Publication
(10) Pub. No.: US 2008/0124685 A1
(43) Pub. Date: May 29, 2008

(54) Method for training auditory skills

(75) Inventor: Josef Chalupper, Paunzhausen (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS AUDIOLGISCHE TECHNIK GMBH

(21) Appl. No.: 11/973,553

(22) Filed: Oct. 9, 2007

(30) Foreign Application Priority Data
Oct. 9, 2006 (DE) 10 2006 047 690.5

(51) Int. Cl. G09B 21/00; H04R 25/00; G10L 15/00

(52) U.S. Cl. 434/112; 381/312

(57) ABSTRACT

The object of the invention is to enable the hearing training of hearing aid wearers to be conducted more effectively without great additional resources. Toward that end it is provided to present in individual training steps a sound sample with the hearing aid and to record and analyze the response of the hearing aid wearer in each case. The training steps are repeated multiple times with different sound samples. At the end of each training step or at the end of the training session, the hearing aid wearer receives feedback on the progress in the training success. This means that the hearing aid wearer can conduct the training himself or herself and yet still receives a professional assessment of the progress of his or her training.

### CROSS REFERENCE TO RELATED APPLICATIONS

This application claims priority of German application No. 10 2006 047 690.5 filed Oct. 9, 2006, which is incorporated by reference herein in its entirety.

### FIELD OF THE INVENTION

The present invention relates to a method for training auditory skills of a hearing aid wearer by presenting a sound sample with the hearing aid, recording and analyzing the hearing aid wearer's response to the sound sample and multiple repetition of a training step including the steps of presenting different sound samples and recording and analyzing as part of a training sequence.

### BACKGROUND OF THE INVENTION

Hearing aids are portable hearing devices which serve to cater for the hearing impaired. In order to accommodate the numerous individual requirements, different designs of hearing aids such as behind-the-ear (BTE) hearing aids, in-the-ear (ITE) hearing aids, and concha hearing aids are made available. The hearing aids cited by way of example are worn on the outer ear or in the auditory canal. In addition, however, bone conduction hearing aids and implantable or vibrotactile hearing aids are also available on the market. With said devices, the damaged hearing is stimulated either mechanically or electrically.

Essential components of hearing aids include in principle an input transducer, an amplifier and an output transducer. The input transducer is generally a receiving transducer, e.g. a microphone and/or an electromagnetic receiver, e.g. an induction coil. The output transducer is mostly implemented as an electroacoustic converter, e.g. a miniature loudspeaker, or as an electromechanical converter, e.g. a bone conduction receiver. The amplifier is typically integrated into a signal processing unit. This basic layout is shown in FIG. 1 using the example of a behind-the-ear hearing aid. One or more microphones 2 for recording ambient sound are integrated into a hearing aid housing 1 designed to be worn behind the ear. A signal processing unit 3, which is also integrated into the hearing aid housing 1, processes the microphone signals and amplifies them. The output signal of the signal processing unit 3 is transmitted to a loudspeaker and/or receiver 4, which outputs an acoustic signal. The sound is optionally transmitted to the ear drum of the hearing aid wearer via a sound tube which is fixed in the auditory canal by means of an otoplastic. The power supply of the hearing aid and in particular of the signal processing unit 3 is provided by a battery 5 which is likewise integrated into the hearing aid housing 1.

Since many sounds cannot be heard due to a hearing loss, the central processing function in the brain of the hearing impaired person become “dishabituated”. That means that although these sounds can once again be heard by means of a hearing aid, they cannot be interpreted by the hearing impaired person because the central processing function in the brain has forgotten how to process these sounds. This is often referred to as “discrimination loss”, “auditory deprivation” or “central processing disorder”. The affected hearing impaired person then typically declares: “I can hear, but I don't understand!”. A phenomenon of this kind is also often observed with children and in connection with dyslexia.

As the brain remains capable of learning into advanced age, it is often possible by targeted hearing training to alleviate or completely rehabilitate processing deficiencies of this kind. The problem is that for this purpose the hearing training has to be carried out as often as possible (including at home) and equipment for presenting sounds is required (e.g. stereo system). Conducting hearing training at short time intervals usually fails on account of the availability and operation of equipment of this kind.

Central processing disorders are often also a reason why hearing aid wearers cannot use the technical possibilities of modern hearing aids to the fullest extent. Thus, for example, the benefit of directional microphones for people with normal hearing is usually greater than for the hearing impaired.

Until now, hearing training was carried out almost exclusively at the practices of acousticians or other appropriately qualified persons in possession of suitable equipment. The hearing training is therefore tied to regular sessions at the practice of said hearing trainer. First of all, that is very problematical for children and senior citizens, which is why this option is only rarely taken up. Furthermore, training of this sort is not very effective, since the hearing cannot be trained outside of the sessions.

A method for presenting functional options of a hearing aid system is described in the post-published specification DE 10 2005 034 381. The individual method steps for presenting the functional options of the hearing aid system can be integrated into a games program. Thus, for example, the hearing can be trained in a targeted manner with the hearing aid by means of hearing puzzles, for example. In addition, spatial hearing can be trained by means of suitable sound samples.

With regard to learning how to interpret presented sounds correctly, reference is made in addition to the following two articles: Wright, B. A. (2001) “Why and how we study human learning on basic auditory tasks”, Audiology and Neuro-Otology 6, 207-210, and Wright, B. A. and Fitzgerald, M. B. (2001), “Different patterns of human discrimination learning for two interaural cues to sound-source location”, PROCEEDINGS OF THE NATIONAL ACADEMY OF SCIENCES Vol. 98, Issue 21, 12307-12312.

The publication DE 103 93 463 T5 discloses a training apparatus which presents a noise-vocoded speech sound signal, receives a response from a trainee and outputs a result which indicates whether the response is correct or incorrect. A plurality of words or sentences can be trained repeatedly.

The publication DE 201 18 619 U1 discloses a difference tone training device for persons with troublesome ear noises. The user has to respond consciously and proactively to a tone prompt of the device with a key acknowledgement. The user's mandatory feedback in response to the provided tone pairs creates a query-response cycle which produces a learning effect after multiple iterations.

### SUMMARY OF THE INVENTION

The object of the present invention consists in structuring the hearing training more effectively for a hearing aid wearer.

This object is achieved according to the invention by means of a method for training auditory skills of a hearing aid wearer by means of the following steps performed by a hearing aid: Presenting a sound sample with the hearing aid, recording and analyzing the response of the hearing aid wearer to the sound sample, and multiple repetitions of a training step including the steps of presenting different sound samples, as well as recording and analyzing within the framework of a training session, and reporting progress in the training success of the training session as feedback to the hearing aid wearer.

By means of the inventive possibility to conduct a hearing training session with the user's own hearing aid and to receive information on the success of the training it is possible to improve and verify the hearing and communication capability for all hearing aid wearers, including those who are unable to take part in regular hearing training sessions. A further advantage that may accrue in certain circumstances is that technical capabilities of modern hearing systems can now be made better use of or used to the full. Thus, for example, directional microphones or an amplification of high frequencies can bring a considerable benefit for successfully trained hearing aid wearers.

Moreover, the inventive hearing training with the hearing aid can also help destigmatize the hearing aid, since it can also be used for the treatment of central processing disorders and dyslexia. The presented method can also be used to support existing hearing training methods.

Within the framework of the method according to the invention, a change in the training success compared to the start of the training is preferably reported during the feedback. This gives the trainee a reference point in relation to the subjective progress of his or her training program.

Alternatively or in addition, during the feedback it is also possible to report a gap in the current training status compared with a person with normal hearing. This enables the trainee to estimate roughly how far the training has already progressed and how long it may still take.

According to a special embodiment of the present invention the training can be used to improve the ability to discriminate between sounds. Toward that end it is advantageous, for example, if during each training step two sounds are presented which differ in the high frequencies, and if during the analysis a discrimination threshold is determined. This allows an objective assessment of the ability to discriminate sounds and enables corresponding feedback to be given to the hearing aid wearer.

According to a further exemplary embodiment the training can be targeted at improving spatial hearing. This training can be structured for example in such a way that at each training step a first sound which is identical for the left and right ear, but has different levels, is presented in each case, and then a second sound which is identical for both ears and also has the same levels, is presented. In this way it is possible to determine an interaural level discrimination threshold which can be used as a benchmark for the spatial hearing.

Furthermore, it is provided according to another exemplary embodiment to improve the temporal resolution of sounds by the hearing aid wearer. This is preferably accomplished in that at each training step a sound pair is presented consisting of a continuous first tone and an interrupted second tone with a predefinable gap in terms of length in each case. In this way it is possible to acquire the gap detection threshold required for the psychoacoustics.

### BRIEF DESCRIPTION OF THE DRAWINGS

The present invention is explained in more detail with reference to the attached drawings, in which:

FIG. 1 shows a diagram depicting the schematic layout of a hearing aid, and

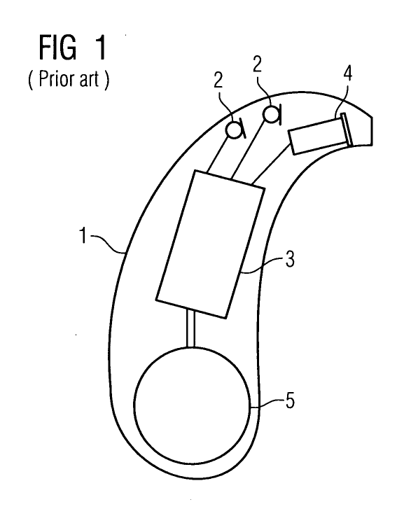

FIG. 2 is a flowchart relating to an exemplary embodiment of the training method according to the invention.

### DETAILED DESCRIPTION OF THE INVENTION

The exemplary embodiments described in more detail below represent preferred embodiments of the present invention.

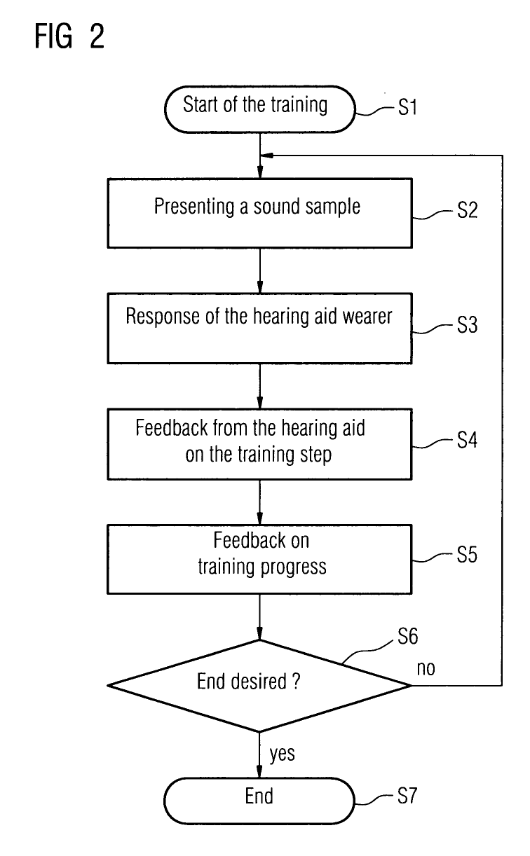

A significant aspect of the present invention is that the hearing training can be conducted by the user solely with the hearing aid and possibly with an associated remote control. Stored on the hearing aid are various exercises which can be started at the press of a button, as indicated symbolically in FIG. 2 with step S1. However, an exercise can also be started for example automatically at certain times or at certain intervals.

After the start, the training session begins with a first training step. In this, a corresponding sound sample is presented to the trainee (step S2). The trainee or hearing aid wearer indicates his or her decision by pressing a button on the hearing aid or the remote control (step S3) and the hearing aid reports back visually or acoustically (step S4) whether the decision was right or wrong. At that point a training step is essentially terminated.

The hearing aid wearer is also given acoustic or visual feedback (step S5) on what progress he or she is making in the training. For this purpose the hearing aid wearer is informed for example about the improvement made compared with the start of the hearing training and/or since the last exercise. Optionally, the hearing aid wearer can also be informed of the gap that separates his or her training status from an average person with normal hearing. The feedback on the progress made can be indicated as in FIG. 2 after each training step S2 to S4 or at the end of the training session before step S7.

If the hearing aid wearer wishes to end the training session at step S6, the session is terminated in accordance with step S7. Otherwise a new training step is initiated at step S2.

The hearing aid acoustician or hearing trainer can select the suitable exercises and the times/intervals by means of customizing software. The customizing software also enables the hearing aid acoustician to print out additional materials (questionnaires, exercise instructions) and to monitor and print the success of the hearing training. The required methods and the likely learning effects are described in the specialist literature by Wright already cited above.

A small selection of possible exercises is presented below. With a coupled hearing system, which can report back the right answer, it is possible in principle to use all the psychoacoustic measuring methods known in the literature (also in conjunction with dynamic stimuli, e.g. dynamic ILD (=Interaural Level Difference)) for the hearing training in the hearing aid.

### EXAMPLE 1

Training to improve the ability to differentiate sounds (discrimination). This training essentially represents a monaural task.

1. The user starts the hearing training session by remote control (by long depression of program switch key or special button) or for example by means of the program switch on the device.

2. The hearing aid plays back in succession two sounds whose spectra at high frequencies are slightly different. A synthesizer or tone generator integrated in the hearing aid is used for this purpose.

3. The user reports back whether the sounds are identical or different. For this purpose he or she uses two keys on the remote control or presses the program switch either once or twice.

4. The hearing aid reports back whether the decision was correct. With this feedback, the hearing aid wearer has completed one learning step.

5. A next sound pair with greater or smaller difference than before is played back, etc.

6. By means of a suitable change in the size of the differences from sound pair to sound pair the discrimination threshold (as of which a difference is audible) is determined and compared with data for persons with normal hearing.

### EXAMPLE 2

Training to improve spatial hearing (ability to differentiate interaural level differences). This is equivalent to a binaural task, i.e. a coupling of both devices is required.

1. The user starts the hearing training session by remote control or by means of the program switch on the device, as above.

2. The hearing aid plays back a sound pair:

Sound 1: the same sound left and right (same spectrum and same phase angle), but at different levels left and right, for, as is well known, the interaural level differences determine the left-right location. If the level on the right is greater than on the left, the noise is perceived as coming from the right.

### Sound 2: the same sound left and right; the level is also the same.

3. The user determines which sound is perceived as “further to the right”.

4. The hearing aid reports back whether the decision was correct. The hearing aid wearer learns on the basis of this feedback.

5. A next sound pair with greater or smaller level difference than before is played back, etc.

6. By means of a suitable change in the size of the differences from sound pair to sound pair the interaural level difference can be determined and compared with data for persons with normal hearing.

### EXAMPLE 3

Training to improve temporal resolution. This also constitutes a monaural task.

1. The user starts the hearing training session by remote control or by means of the program switch on the device, as in the above examples.

2. The hearing aid plays back a sound pair:

### Sound 1: continuous tone;

### Sound 2: tone with short pause (“gap”). It is important to know in this regard that if the pauses are sufficiently short the hearing perceives a continuous tone.

3. The user determines which sound has a gap.

4. The hearing aid reports back whether the decision was correct. The hearing aid wearer learns as a result.

5. A next sound pair with bigger or smaller gap than before is played back, etc.

6. By a suitable change in the size of the differences from sound pair to sound pair the gap detection threshold can be determined and compared with data for persons with normal hearing.

Each of the above-described training examples represents a type of training which the hearing aid wearer himself or herself can perform at any time with his or her hearing aid. Thus, the training can be conducted often without need for additional resources, with the result that a desired training success can be achieved relatively quickly.

1.-6. (canceled)

7. A method for training an auditory skill of a hearing aid wearer in a training session, comprising:
presenting a first sound sample to the hearing aid wearer;
recording a first response of the hearing aid wearer to the first sound sample;
analyzing the first response;
presenting a second sound sample to the hearing aid wearer;
recording a second response of the hearing aid wearer to the second sound sample;
analyzing the second response; and
feeding back a progress of the auditory skill of the hearing aid wearer in a success of the training session to the hearing aid wearer.

8. The method as claimed in claim 7, wherein a change of the auditory skill of the hearing aid wearer between the success of the training session and a start of the training session is compared and reported in the feedback.

9. The method as claimed in claim 7, wherein a gap between the auditory skill of the hearing aid wearer in a current training status of the training session and a person with normal hearing is compared and reported in the feedback.

10. The method as claimed in claim 7, wherein the first and the second sound samples differ in high frequencies and a discrimination threshold is determined during the analysis.

11. The method as claimed in claim 7, wherein the first sound sample is identical for a left ear and a right ear of the hearing aid wearer but has different levels and the second sound sample is identical for the left ear and the right ear of the hearing aid wearer and also has identical levels.

12. The method as claimed in claim 7, wherein the first sound sample is a continuous tone and the second sound sample is an interrupted tone with a length of a gap that is predefined.

13. A hearing aid for training an auditory skill of a hearing aid wearer in a training session, comprising:
a sound receiver that receives a plurality of sound samples;
a processing unit that:
receives a plurality of responses from the hearing aid wearer corresponding to the sound samples,
analyzes the responses, and
feeds back a progress in a success of the training session to the hearing aid wearer.

14. The hearing aid as claimed in claim 13, a change of the auditory skill of the hearing aid wearer between the success of the training session and a start of the training session is compared and reported in the feedback.

15. The hearing aid as claimed in claim 13, wherein a gap between the auditory skill of the hearing aid wearer in a current training status of the training session and a person with normal hearing is compared and reported in the feedback.

16. The hearing aid as claimed in claim 13, wherein the sound samples comprises a first sound sample and a second sound sample.

17. The hearing aid as claimed in claim 16, wherein the first and the second sound samples differ in high frequencies and a discrimination threshold is determined during analysis.

18. The hearing aid as claimed in claim 16, wherein the first sound sample is identical for a left ear and a right ear of the hearing aid wearer but has different levels and the second sound sample is identical for the left ear and the right ear of the hearing aid wearer and also has identical levels.

19. The hearing aid as claimed in claim 16, wherein the first sound sample is a continuous tone and the second sound sample is an interrupted tone with a length of a gap that is predefined.
